(19) United States
(12) Patent Application Publication
(10) Pub. No.: US 2026/0095948 A1
(43) Pub. Date: Apr. 2, 2026

(54) STATE-BASED RANDOM ACCESS RESOURCES FOR WIRELESS COMMUNICATION

(71) Applicant: QUALCOMM Incorporated, San Diego, CA (US)

(72) Inventors: Chiranjib SAHA, Lakeside, CA (US); Ayan SENGUPTA, San Diego, CA (US); Alberto RICO ALVARINO, San Diego, CA (US); Xiao Feng WANG, San Diego, CA (US)

(21) Appl. No.: 18/902,812

(22) Filed: Sep. 30, 2024

(51) Int. Cl. H04W 74/0833; H04W 72/51

(52) U.S. Cl. CPC H04W 74/0833; H04W 72/51

(57) ABSTRACT

Methods, systems, and devices for wireless communications are described. A user equipment (UE) may receive control information that indicates a first pool of random access (RACH) resources for UEs in a global navigation satellite system (GNSS)-available state and a second pool of RACH resources for UEs in a GNSS-less state. The second pool may include longer RACH preambles, longer RACH occasions, or a RACH preamble format associated with a greater quantity of propagation paths compared to the first pool. In response to the transitioning GNSS states during a RACH procedure, a UE may perform RACH failure operations, indicate the transition to a higher layer, get new RACH resources from a same or different pool, or any combination thereof. Additionally, or alternatively, the UE may indicate the transition, the different GNSS state, or both, to a non-terrestrial network entity in a RACH message of the RACH procedure or in dedicated signaling.

### FIELD OF TECHNOLOGY

The following relates to wireless communications, including state-based random access resource for wireless communication.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving control information that indicates a first pool of random access (e.g., random access channel (RACH)) resources for UEs in a first state with respect to a navigation satellite system (e.g., a global navigation satellite system (GNSS)) and a second pool of RACH resources for UEs in a second state with respect to the GNSS, where at least one RACH resource in the first pool of RACH resources is not included in the second pool of RACH resources or at least one RACH resource in the second pool of RACH resources is not included in the first pool of RACH resources and transmitting a first RACH message using a first RACH resource, where whether the first RACH resource is from the first pool of RACH resources or the second pool of RACH resources is based on a state of the UE with respect to the GNSS.

A UE for wireless communications is described. The UE may include one or more memories storing processor executable code, a transceiver, and one or more processors coupled with the one or more memories and the transceiver. The one or more processors may individually or collectively be operable to execute the code to cause the UE to receive, via the transceiver, control information that indicates a first pool of RACH resources for UEs in a first state with respect to a GNSS and a second pool of RACH resources for UEs in a second state with respect to the GNSS, where at least one RACH resource in the first pool of RACH resources is not included in the second pool of RACH resources or at least one RACH resource in the second pool of RACH resources is not included in the first pool of RACH resources and transmit, via the transceiver, a first RACH message using a first RACH resource, where whether the first RACH resource is from the first pool of RACH resources or the second pool of RACH resources is based on a state of the UE with respect to the GNSS.

Another UE for wireless communications is described. The UE may include means for receiving control information that indicates a first pool of RACH resources for UEs in a first state with respect to a GNSS and a second pool of RACH resources for UEs in a second state with respect to the GNSS, where at least one RACH resource in the first pool of RACH resources is not included in the second pool of RACH resources or at least one RACH resource in the second pool of RACH resources is not included in the first pool of RACH resources and means for transmitting a first RACH message using a first RACH resource, where whether the first RACH resource is from the first pool of RACH resources or the second pool of RACH resources is based on a state of the UE with respect to the GNSS.

A non-transitory computer-readable medium storing code for wireless communications is described. The code may include instructions executable by one or more processors to receive control information that indicates a first pool of RACH resources for UEs in a first state with respect to a GNSS and a second pool of RACH resources for UEs in a second state with respect to the GNSS, where at least one RACH resource in the first pool of RACH resources is not included in the second pool of RACH resources or at least one RACH resource in the second pool of RACH resources is not included in the first pool of RACH resources and transmit, via the transceiver, a first RACH message using a first RACH resource, where whether the first RACH resource is from the first pool of RACH resources or the second pool of RACH resources is based on a state of the UE with respect to the GNSS.

In some examples of the method, UEs, and non-transitory computer-readable medium described herein, RACH resources in the first pool of RACH resources may be in accordance with a first set of parameter values and RACH resources in the second pool of RACH resources may be in accordance with a second set of parameter values, the first set of parameter values and the second set of parameter values share a common set of parameter values, to indicate the RACH resources in the first pool, the control information indicates each of the first set of parameter values including the common set of parameter values, and to indicate the RACH resources in the second pool, the control information indicates each of the second set of parameter values excluding the common set of parameter values.

In some examples of the method, UEs, and non-transitory computer-readable medium described herein, the first RACH resource may be from the second pool of RACH resources based on the state of the UE with respect to the GNSS including the UE being unable to obtain its location using the GNSS, the UE being incapable of using the GNSS, an expiration of a GNSS validity timer, a resource selection probability factor indicated in the control information, or any combination thereof.

In some examples of the method, UEs, and non-transitory computer-readable medium described herein, the second pool of RACH resources includes longer RACH preambles than the first pool of RACH resources, longer RACH occasions than the first pool of RACH resources, RACH preambles having a format associated with a greater quantity of propagation paths than the first pool of RACH resources, or any combination thereof.

Some examples of the method, UEs, and non-transitory computer-readable medium described herein may further include operations, features, means, or instructions for transmitting, via the transceiver, a second RACH message using a second RACH resource from a different pool of RACH resources, where whether the different pool of RACH resources may be the first pool of RACH resources or the second pool of RACH resources may be based on whether the UE may have transitioned, during or after transmission of the first RACH message, from the first state to the second state or from the second state to the first state.

Some examples of the method, UEs, and non-transitory computer-readable medium described herein may further include operations, features, means, or instructions for resetting a RACH transmission counter based on the second RACH resource being from the different pool of RACH resources than the first RACH resource.

Some examples of the method, UEs, and non-transitory computer-readable medium described herein may further include operations, features, means, or instructions for performing one or more RACH failure operations based on a transition of the UE, during or after transmission of the first RACH message, to a different state of the UE with respect to the GNSS.

Some examples of the method, UEs, and non-transitory computer-readable medium described herein may further include operations, features, means, or instructions for indicating the transition of the UE to the different state as a cause of RACH failure to an upper layer of the UE based on performing the one or more RACH failure operations.

Some examples of the method, UEs, and non-transitory computer-readable medium described herein may further include operations, features, means, or instructions for transmitting, via the transceiver, a second RACH message using a second RACH resource, where the second RACH resource and the first RACH resource may be from a same pool of RACH resources despite a transition of the UE, during or after transmission of the first RACH message, to a different state of the UE with respect to the GNSS.

Some examples of the method, UEs, and non-transitory computer-readable medium described herein may further include operations, features, means, or instructions for receiving, via the transceiver and in response to the first RACH message, a RACH response (e.g., random access response (RAR)) message indicating information associated with an uplink frequency adjustment for a third RACH message.

Some examples of the method, UEs, and non-transitory computer-readable medium described herein may further include operations, features, means, or instructions for receiving, via the transceiver and in response to the first RACH message, a RACH response message and transmitting, via the transceiver and in response to the RACH response message, a third RACH message that indicates a transition of the UE to a different state of the UE with respect to the GNSS, the different state, or both.

Some examples of the method, UEs, and non-transitory computer-readable medium described herein may further include operations, features, means, or instructions for entering a connected mode based on transmitting the first RACH message and transmit, via the transceiver and after entering the connected mode, an indication of a transition of the UE, during or after transmission of the first RACH message, to a different state of the UE with respect to the GNSS, the different state, or both.

In some examples of the method, UEs, and non-transitory computer-readable medium described herein, based on the first RACH resource being from the second pool of RACH resources, a timing advance, frequency adjustment, or any combination thereof associated with the first RACH message may be based on a common timing advance for UEs in the second state, a common frequency adjustment for UEs in the second state, one or more derivatives of the common timing advance, one or more derivatives of the common frequency adjustment, a validity duration associated with the common timing advance or the common frequency adjustment, a reference location for UEs in the second state, a location drift associated with the reference location, a location drift rate associated with the reference location, a validity duration associated with the reference location, one or more timing advance commands or frequency adjustment commands received by the UE within a duration of time or stored in a buffer at the UE, or any combination thereof.

In some examples of the method, UEs, and non-transitory computer-readable medium described herein, the first RACH resource may be from the first pool of RACH resources based on the state of the UE being the first state and the method, apparatuses, and non-transitory computer-readable medium may include further operations, features, means, or instructions for transmitting, via the transceiver and based on failing to receive a RACH response message in response to the first RACH message, a third RACH message using a second RACH resource from the second pool of RACH resources despite being in the first state.

Some examples of the method, UEs, and non-transitory computer-readable medium described herein may further include operations, features, means, or instructions for applying a timing advance, a frequency adjustment, or both, to the third RACH message based on measurements of one or more signals from the GNSS.

In some examples of the method, UEs, and non-transitory computer-readable medium described herein, the control information includes a flag indicating whether a cell associated with the control information supports RACH procedures for UEs in the second state with respect to the GNSS.

In some examples of the method, UEs, and non-transitory computer-readable medium described herein, the first state with respect to the GNSS includes the UE being able to obtain its location using the GNSS, being capable of using the GNSS, or both and the second state with respect to the GNSS includes the UE being unable to obtain its location using the GNSS, being incapable of using the GNSS, or both.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports state-based random access (e.g., random access channel (RACH)) resource for wireless communication in accordance with one or more aspects of the present disclosure.

FIG. 2 shows an example of a wireless communications system that supports state-based RACH resource for wireless communication in accordance with one or more aspects of the present disclosure.

FIG. 3 shows an example of a resource diagram that supports state-based RACH resource for wireless communication in accordance with one or more aspects of the present disclosure.

FIG. 4 shows an example of a process flow that supports state-based RACH resource for wireless communication in accordance with one or more aspects of the present disclosure.

FIGS. 5 and 6 show block diagrams of devices that support state-based RACH resource for wireless communication in accordance with one or more aspects of the present disclosure.

FIG. 7 shows a block diagram of a communications manager that supports state-based RACH resource for wireless communication in accordance with one or more aspects of the present disclosure.

FIG. 8 shows a diagram of a system including a device that supports state-based RACH resource for wireless communication in accordance with one or more aspects of the present disclosure.

FIG. 9 shows a flowchart illustrating methods that support state-based RACH resource for wireless communication in accordance with one or more aspects of the present disclosure.

### DETAILED DESCRIPTION

In some memory systems, a user equipment (UE) may enter a connected mode (e.g., establish a connection) with a non-terrestrial network (NTN) entity (e.g., a satellite supporting a wireless network) based on communicating one or more random access messages (e.g., random access channel (RACH) messages) in a random access procedure (e.g., a RACH procedure). Due to a large distance between the UE and the NTN entity, a high speed of the NTN entity relative to the UE, or both, the UE may apply one or more offsets (e.g., a timing advance, a frequency adjustment) to the RACH messages to synchronize the communications and account for Doppler affects between the UE and the NTN entity. In some examples, the UE may determine location information (e.g., coordinates, speed) associated with the UE by passively measuring signals from a global navigation satellite system (GNSS) (e.g., from a GNSS entity, from a satellite of the GNSS) and may use the location information to determine the one or more offsets for the RACH messages. Herein, as random access procedures may be performed via a RACH, resources, message, and procedures associated with random access procedures may generally be referred to RACH resources, RACH messages, and RACH procedures; however, the teachings herein related to such resources, messages, and procedures are not limited to use in connection with a single type of channel and may instead be incorporated to support random access regardless of channel type.

However, not all UEs may have access to the GNSS at all times. For example, a GNSS state of the UE (e.g., a state of the UE with respect to the GNSS) may change, where the GNSS state of the UE may be either a GNSS-available state (e.g., the UE is able to determine its location based on the GNSS, or the UE is capable of using the GNSS) or a GNSS-less state (e.g., the UE is unable to determine its location based on the GNSS, or the UE is incapable of using the GNSS). A UE may be incapable of using the GNSS because it lacks one or more components (e.g., hardware or software components) or access permissions (e.g., subscriptions) required to facilitate use of the GNSS. Conversely, a UE may be capable of using the GNSS because it has associated capability (e.g., hardware capability based on having one or more associated hardware components, software capability based on having one or more associated software components, one or more access permissions, or any combination thereof). A UE may be unable to obtain its location using the GNSS due to some more temporary condition (such as signal blockage or being in a low power state for example) that prevents an otherwise GNSS-capable UE from being able to obtain its location using the GNSS at some particular time. A UE that is capable of using the GNSS may be able to obtain its location using the GNSS when operating conditions (e.g., signal quality conditions, battery state conditions) allow. As used herein, a UE may be able or unable to obtain its location using the GNSS due to an ability or inability of the UE to obtain its location using that particular GNSS (e.g., due to an ability or inability that is specific to one GNSS) or due to an ability or inability of the UE to obtain its location using satellite-based navigation or positioning generally (e.g., due an ability or inability that is applicable to any GNSS). Similarly, as used herein, a UE may be capable or incapable of using the GNSS due to a capability or incapability of the UE to use that particular GNSS (e.g., due to a capability or incapability that is specific to one GNSS) or due to a capability or incapability of the UE to use satellite-based navigation or positioning generally (e.g., due a capability or incapability that is applicable to any GNSS).

In some cases, UEs in the GNSS-less state may experience inefficiencies or increased failures in connecting with the NTN entity using the RACH procedure. Additionally, or alternatively, UEs that transition between GNSS states (e.g., to the GNSS-less state) while performing the RACH procedure or connected to the NTN entity may lose connection (e.g., lose uplink synchronization, declare radio link failure, transition to RRC_Idle). Thus, techniques to improve the ability of UEs to enter and stay in the connected mode with the NTN entity regardless of a GNSS state of the UEs may be beneficial.

According to techniques described herein, a UE may receive control information (e.g., system information block 1 (SIB1), other system information) that indicates two pools of random access resources (e.g., RACH resource), including a first pool of random access resources (e.g., RACH resources) for UEs in the GNSS-available state (e.g., a GNSS-available pool) and a second pool of RACH resources for UEs in the GNSS-less state (e.g., a GNSS-less pool). For example, UEs in the GNSS-available state may use a RACH resources from the GNSS-available pool to perform at least an initial RACH attempt (e.g., communicating at least a first RACH message) with an NTN entity, and UEs in the GNSS-less state may use a RACH resource from the GNSS-less pool to perform at least an initial RACH attempt with the NTN entity. In some examples, the GNSS-less pool may include longer random access preambles (e.g., RACH preambles), longer RACH occasions, RACH preambles having a format associated with a greater quantity of propagation paths, or any combination thereof, compared to the GNSS-available pool.

In some examples, the UE may transition to a different GNSS state (e.g., switch from the GNSS-available state to the GNSS-less state, or vice versa, a different state) while performing a RACH procedure (e.g., during or after transmitting a first RACH message of the RACH procedure, before entering a connected mode with the NTN entity). In response to the transition, the UE may perform one or more actions, which may include performing random access failure operations (e.g., RACH failure operations), indicating the transition as a RACH failure cause to a higher layer, continuing or restarting the RACH procedure with RACH resources from a different or same pool of RACH resources, or any combination thereof. Additionally, or alternatively, the UE may indicate the transition, the different GNSS state, or both, to the NTN entity in a RACH message of the RACH procedure or in dedicated signaling after entering the connected mode with the NTN entity.

Aspects of the disclosure are initially described in the context of wireless communications systems. Aspects of the disclosure are also described in the context of resource diagrams and process flows. Aspects of the disclosure are further illustrated by and described with reference to apparatus diagrams, system diagrams, and flowcharts that relate to state-based random access resource for wireless communication.

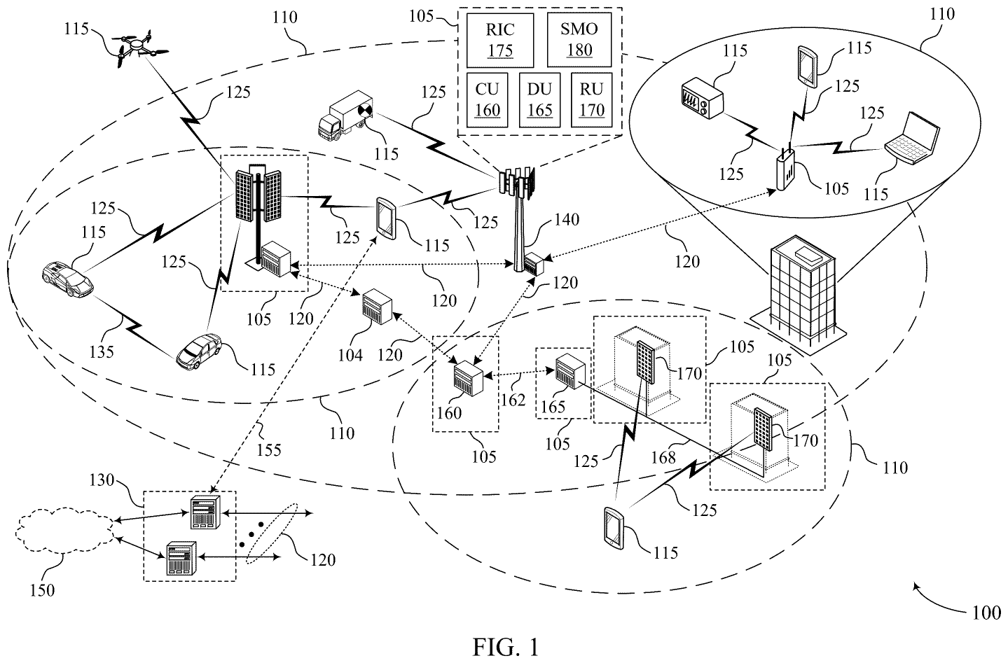

FIG. 1 shows an example of a wireless communications system 100 that supports state-based RACH resource for wireless communication in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples described herein, the network entities 105 my include one or more NTN entities of an NTN, where the NTN entities may be mobile or fixed satellites (e.g., geosynchronous orbit (GSO) or non-GSO (NGSO) satellites) that perform one or more same functions as the network entities 105. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support state-based RACH resource for wireless communication as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

According to techniques described herein, a UE 115 may receive control information (e.g., system information block 1 (SIB1), other system information) that indicates two pools of RACH resource, including a first pool of RACH resources for UEs in the GNSS-available state (e.g., a GNSS-available pool) and a second pool of RACH resources for UEs in the GNSS-less state (e.g., a GNSS-less pool). For example, UEs 115 in the GNSS-available state may use a RACH resources from the GNSS-available pool to perform at least an initial RACH attempt (e.g., communicating at least a first RACH message) with an NTN entity (e.g., an example of a network entity 105, in some aspects), and UEs 115 in the GNSS-less state may use a RACH resource from the GNSS-less pool to perform at least an initial RACH attempt with the NTN entity. In some examples, the GNSS-less pool may include longer RACH preambles, longer RACH occasions, RACH preambles having a format associated with a greater quantity of propagation paths, or any combination thereof, compared to the GNSS-available pool.

In some examples, the UE 115 may transition to a different GNSS state (e.g., switch from the GNSS-available state to the GNSS-less state, or vice versa) while performing a RACH procedure (e.g., during or after transmitting a first RACH message of the RACH procedure, before entering a connected mode with the NTN entity). In response to the transition, the UE 115 may perform one or more actions, which may include performing RACH failure operations, indicating the transition as a RACH failure cause to a higher layer of the UE 115, continuing or restarting the RACH procedure with RACH resources from a different or same pool of RACH resources, or any combination thereof. Additionally, or alternatively, the UE 115 may indicate the transition, the different GNSS state, or both, to the NTN entity in a RACH message of the RACH procedure or in dedicated signaling after entering the connected mode with the NTN entity.

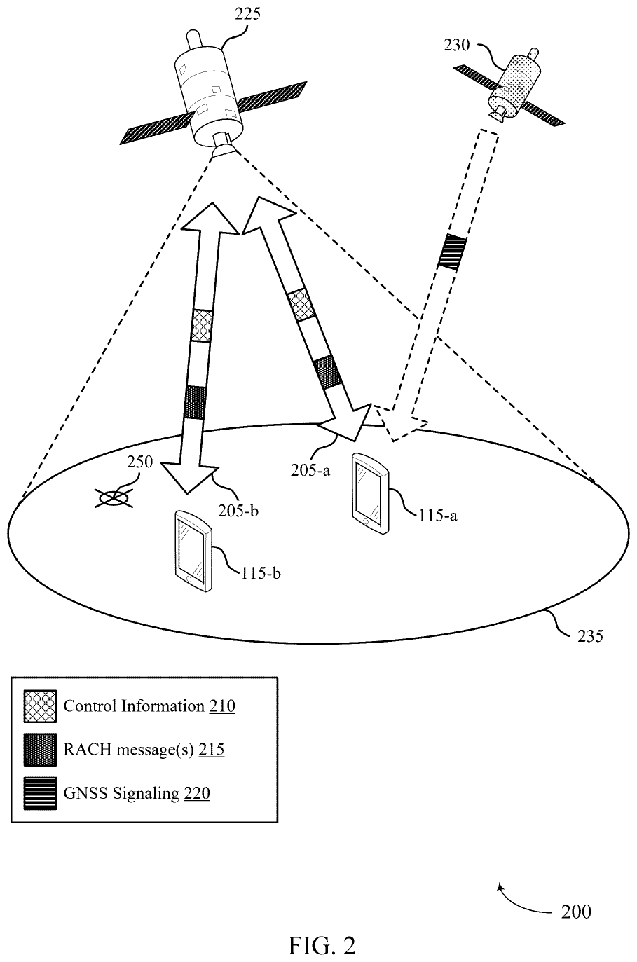

FIG. 2 shows an example of a wireless communications system 200 that supports state-based RACH resource for wireless communication in accordance with one or more aspects of the present disclosure. In some cases, aspects of the wireless communications system 200 may implement or be implemented by aspects of FIG. 1. For example, the wireless communications system 200 may include an NTN entity 225 (e.g., an example of a network entity 105, including an NTN entity, described with respect to FIG. 1), UEs 115 (e.g., a UE 115-a, a UE 115-b, an example of the UEs 115 as described with respect to FIG. 1), and a cell 235 (e.g., an example of the cells or coverage areas 110 as described with respect to FIG. 1). The wireless communications system 200 may also include one or more GNSS entities 230 (e.g., a GNSS satellite), which may be part of a GNSS. In some aspects, the UE 115-a may be in the GNSS-available state and the UE 115-b may be in the GNSS-less state. Additionally, each UE 115 may receive control information 210 indicating the GNSS-available pool of RACH resources and the GNSS-less pool of RACH resources, and may communicate one or more RACH message(s) 215 with the NTN entity 225 based on the GNSS state of the UE 115.

In some cases, the UE 115-a and the UE 115-b may enter a connected mode (e.g., establish a connection 205) with the NTN entity 225 while in a GNSS-available state and the GNSS-less state, respectively. For example, in the GNSS-less state (e.g., unable to or incapable of using a GNSS to determine location information), the UE 115-b may receive, from the NTN entity 225 (e.g., and the NTN) communication service during emergencies or disaster, for military uses, or for some indoor or vehicular uses. In some aspects, the connections 205 (e.g., a connection 205-a, a connection 205-b) between the UEs 115 and the NTN entity 225 may be supplementary to or a substitute for communicating with the GNSS entity 230. For example, the UE 115-a being in the GNSS state (e.g., communicating with the GNSS entity 230) may allow for more efficient and high-performance communications between the UE 115-a and the NTN entity 225, but the NTN entity 225 may also provide resilient services to the UE 115-b in the GNSS-available state.

The UEs 115 may communicate one or more signals (e.g., time-continuous signals, such as the RACH message(s) 215) with the NTN entity 225 based on being in the connected mode with the NTN entity. In some cases, a signal communicated from or to the UEs 115 (e.g., via an antenna port and subcarrier spacing configuration) via one or more OFDM symbols in a subframe for any physical channel or signal (e.g., except for the physical random access channel (PRACH)) may be defined using a cyclic prefix (e.g., a RACH sequence). In some examples, the cyclic prefix may be an extended (e.g., long) cyclic prefix or a normal (e.g., short) cyclic prefix. In some examples, the cyclic prefix may reduce inter-symbol interference (ISI) and generally improve a quality of the signal.

In some cases, an uplink frame from one of the UEs 115 may correspond to a downlink frame at the UE 115. For example, an uplink frame for transmission from the UE 115 may start before a corresponding downlink frame by a timing advance T_{TA} (e.g., in units of time, including seconds, frames, symbols, or any combination thereof). In some cases, the timing advance may be based on one or more quantities. For example, the timing advance T_{TA} may be determined by Equation 1:

$${T}_{TA} = ( {N}_{TA} + {N}_{TA , offset} + {N}_{TA , adj common} + {N}_{TA , adj UE} ) {T}_{c} \qquad ( Eq . 1 )$$

n Equation 1, N_{TA} may be a base timing advance (e.g., and may be set to zero for PRACH or RACH signaling), N_{TA,Offset} may be a timing advance offset which may be indicated to or derived by the UE 115 via one or more control signals (e.g., ServiceCellConfigCommon, ServiceCellConfigCommonSIB), N_{TA,adj common} may be a timing advance adjustment that is common for a cell (e.g., indicated to the UE 115 by one or more control signals), N_{TA,adj UE} may be a UE-specific timing advance adjustment, and T_{C} may be a timing constant (e.g., 1/(480 kHz*4096)=0.509 nanosecond). As used herein, an “offset” or “timing advance” may refer to T_{TA}, one or more variables from Equation 1, or any combination thereof. In addition to, or alternatively to, the timing advance, a UE 115 may compensate for a Doppler shift associated with communications with the NTN entity 225 using a frequency adjustment, to which the term “offset” may also refer. Additionally, the timing advance may be for used for signaling between the UEs 115 and the NTN entity 225 (e.g., via a service link) and for communications with a reference location 250 (e.g., via a feeder link).

In some cases, the NTN entity 225 (e.g., or another network entity 105) may transmit one or more timing advance commands (e.g., or frequency adjustment commands) to the UEs 115. For example, the NTN entity 225 may transmit the one or more timing advance commands to a UE 115 based on a UE 115 erroneously estimating the location of the UE 115 (e.g., detected by the NTN entity 225 based on an error in the UE adjusted timing advance), or one or more issues with a timing advance that is common for the cell 235. The timing advance command may indicate at least a portion of the timing advance described above. In some cases, the UEs 115 may have a buffer time (e.g., a minimum quantity of slots, frames, subframes, or another unit of time) to apply the timing advance indicated by a timing advance command to signaling from the UE 115. For example, if a UE 115 receives the timing advance command in a slot n, the UE 115 may apply the timing in a slot n+k+l, where k+l may account for a physical downlink shared channel (PDSCH) processing time at the UE 115, a maximum timing advance that may be indicated (e.g., provided) by the timing advance command, a physical uplink shared channel (PUSCH) preparation time, or any combination thereof.

In some cases, the UEs 115 may communicate (e.g., transmit, receive) the RACH message(s) 215 as part of a RACH procedure with the NTN entity 225. In the case of four step RACH, the RACH message(s) 215 may include four messages—Msg1, Msg2, Msg3, and Msg4. To support transmission of the Msg1 (e.g., a preamble transmission, a first RACH message), a UE 115 may select a RACH preamble (e.g., RACH sequence) from a set of predefined preambles. Each preamble may have one of two formats (e.g., in one of two approximate categories): short preamble format and long preamble format. In some examples, the long preamble format may increase a latency of communicating the Msg1, but may be a more robust Msg1 (e.g., less susceptible to noise and asynchronization). In some cases, the UE 115 may also select a random sequence number for the preamble. After choosing the preamble and sequence number, the UE 115 may transmit the preamble on a physical random access channel (PRACH).

In response to receiving Msg1, the NTN entity 225 (e.g., a network entity 105) may send a response called Msg2 (e.g., a random access response (RAR) message, a second RACH message). Msg2 may include several pieces of information, such as the time advance command for timing adjustment, a random access preamble ID (RAPID) that matches the preamble sent by the UE 115 in the Msg1, and an initial uplink grant for the UE 115. The NTN entity 225 may also assign a temporary identifier called a random access radio network temporary identifier (RA-RNTI) to the UE 115 via the Msg2.

Using the initial uplink grant provided in Msg2, the UE 115 may transmit a Msg3 (e.g., a third RACH message) on a PUSCH. Msg3 may be a shared uplink transmission (e.g., a PUSCH) which may carry one or more RRC messages (e.g., RrcRequest), or may carry physical later (PHY) data.

After processing Msg3, the NTN entity 225 may send a Msg4 (e.g., a contention resolution message, a fourth RACH message) to the UE 115. Msg4 may be a medium access control MAC data message for contention resolution. The contention resolution message may include an identity of the UE 115, which may confirm that the NTN entity 225 has correctly identified the UE 115, that contention has been resolved, or both. In addition to or with the Msg4, the NTN entity 225 may provide the UE 115 with a cell radio network temporary identifier (C-RNTI).

In some wireless communications systems (e.g., legacy NR), the NTN entity 225 may assumes that the UEs 115 are in the GNSS-available state, and may apply a non-zero timing advance and frequency adjustment during uplink transmissions (e.g., PRACH, physical uplink control channel (PUCCH), PUSCH, sounding reference signals (SRS)) form the UEs 115. However, if a UE 115 transitions to the GNSS-less state (e.g., loses GNSS) while in a radio resource control (RRC) connected mode with the NTN entity 225, the UE 115 may eventually lose an uplink synchronization with the NTN entity 225, declare a radio-link failure, and transition to an idle mode (e.g., RRC_Idle) from the connected mode. Thus, the techniques described herein may increase the ability of UEs in the GNSS-less state (e.g., without GNSS) to connect with the NTN entity 225. Additionally, the techniques described herein may be applied to UEs 115 in any mode with respect to a communication link (e.g., in RRC_Idle mode, connected mode, inactive mode).

In some aspects, the NTN entity 225 (e.g., or a network entity 105, such as a g-node-B (gNB)) may transmit (e.g., broadcast, for example in SIB1) control information indicating a first RACH resource-pool (e.g., GNSS-available pool) for UEs 115 in the GNSS-available state (e.g., for legacy) and a second RACH resource-pool (e.g., GNSS-less pool) for UEs 115 in the GNSS-less state. When transmitting the RACH message(s) 215, a UE 115 may select a RACH resources for the RACH message(s) 215 from the pool of RACH resources associated with the GNSS state in which the UE 115 is.

In some cases, RACH resources in the GNSS-less pool may share some common parameter values (e.g., common parameter values for the parameters preambleTransMax, PowerRampingStep, among other possible parameters that may collectively define a RACH resource or control the use thereof) with the RACH resources in GNSS-available pool. The parameter preambleTransMax may refer, for example, to a maximum quantity of RACH preamble transmissions that may occur as part of a single RACH procedure, while the parameter PowerRampingStep may refer, for example, to a power ramping factor and thus to an amount by which transmission power may be increased from one RACH preamble transmission to the next as part of a single RACH procedure. For other parameters that may collectively define a RACH resource or control the use thereof, the corresponding parameter values may be different as between the RACH resources in the GNSS-less pool and the RACH resources in GNSS-available pool. For example, RACH resources in the GNSS-less pool may have different base RACH sequences (e.g., preamble sequences), different PRACH formats, different cyclic shifts, or any combination thereof) relative to RACH resources in GNSS-available pool.

In some examples, the values of parameters having common values across the GNSS-less pool and the GNSS-available pool may be omitted in the signaling (e.g., information element or other configuration message) that indicates the configuration of the GNSS-less pool resources. For example, first signaling (e.g., a first information element, a first configuration message) may configure the RACH resources in the GNSS-available pool, which may include indicating a set of parameter values applicable to the RACH resources in the GNSS-available pool. Second signaling (e.g., a first information element, a first configuration message) may configure the RACH resources in the GNSS-less pool. The first signaling may indicate the values of all parameters for the RACH resources in the GNSS-available pool. However, to reduce signaling overhead, the second signaling may indicate values only for those parameters whose value is different for the RACH resources in the GNSS-less pool relative to the RACH resources in the GNSS-available pool. For other parameters for which a value is not indicated by the second signaling, the values may be interpreted by the UE 115 as being the same as the values indicated in the first signaling for the RACH resources in the GNSS-available pool (e.g., as having common values across the pools). Thus, for example, a UE 115 in the GNSS-less state may determine or use a RACH resource for the RACH message(s) 215 using one or more pool-specific parameter values that are indicated in the configuration information that is specific to the GNSS-less pool and also using one or more common parameter values indicated via the separate configuration information for the GNSS-available pool.

In some cases, the UE 115-b (e.g., a UE 115 without GNSS or in GNSS-less state) may use the GNSS-less pool to derive a RACH resource (e.g., a RACH sequence, a RACH preamble, a RACH occasions (RO)) for communicating the RACH message(s) 215. In some cases, the UE 115-b may be in the GNSS-less state based on one or more conditions. For example, the UE 115-b may be in the GNSS-less state based on a GNSS sensor not being present (e.g., a UE that is incapable of using satellite-based navigation or positioning), not functioning, or not being accessible at the moment and/or based on being without GNSS capabilities, based on an expiration of a timer (e.g., a GNSS validity timer, a UE GNSS sensor not available (NA), etc.), or a resource selection probability (e.g., indicated in a SIB, indicated in control information) that randomly (according to the resource selection probability) allows UEs 115 in the GNSS-available state (e.g., such as the UE 115-a) to use RACH resources from the GNSS-less pool (e.g., irrespective of the GNSS state of the UE 115).

In some cases, the UE may transition from an initial GNSS state to a different GNSS state (e.g., from the GNSS-available state to the GNSS-less state, or vice-versa) while transmitting (e.g., during or after transmission of) a first RACH message 215 (e.g., Msg1, when the UE 115 is retrying the RACH procedure). In one example, the UE 115 may implicitly declare a Msg1 transmission failure (e.g., performing one or more internal RACH failure operations without indicating the RACH failure to an upper layer), and may retry transmitting the first RACH message 215 according to a RACH resource from the RACH resource pool associated with the different GNSS state. Additionally, or alternatively, the UE 115 may reset a random access transmission (e.g., RACH transmission) counter (e.g., PREAMBLE_TRANSMISSION_COUNTER) if the RACH resource pool used to retry transmitting the first RACH message 215 (e.g., the GNSS-less pool, for example) is different from the RACH pool used to transmit the initial first RACH message 215 (e.g., the GNSS-available pool, for example). In another example, the UE 115 may declare a RACH failure (e.g., performing one or more RACH failure operations), which may include informing an upper layer of the RACH problem (e.g., indicate RACH failure cause of GNSS state change, a RACH failure value indicates GNSS state change). In yet another example, the UE 115 may continue the ongoing random access procedure in spite of the transition to the different GNSS state. For example, the UE 115 may retransmit the first RACH message using a different resource from the RACH resource pool associated with the initial GNSS state, or may continue the operations of the RACH procedure as if the UE 115 had not transitioned to the different GNSS state.

In some cases, the NTN entity 225 may utilize a different Msg2 (e.g., RAR MAC control element (CE)) based on the RACH resources used by the UE 115 to transmit the RACH message(s) 215. For example, if the UE 115 transmits the RACH message(s) 215 using RACH resources from the GNSS-less pool, the Msg2 may include at least some information related to an initial uplink frequency adjustment for further communication between the UE 115 and the NTN entity 225 (e.g., along with timing advance information).

In some cases, the GNSS state of a UE 115 may transition from an initial GNSS state to a different GNSS state (e.g., the UE 115 may transition from the GNSS-available state to GNSS-less state) before communication of the Msg3 (e.g., after the communication of the Msg1 and before communication of the Msg3). In one such examples, the UE 115 may transmit the Msg3 according to the RACH resources associated with the initial GNSS state, where the Msg3 may indicate the transition of the GNSS state, the different GNSS state, or both. In another such examples, the UE 115 may not indicate the transition, the GNSS state, or both, to the NTN entity until after transitioning to (e.g., entering) a connected mode with the NTN entity 225. Then the UE 115 may inform the NTN entity 225 (e.g., using dedicated signaling) of the transition, the different GNSS state, or both.

In some cases, the UE may apply one or more offsets (e.g., a UE adjusted timing advance, a frequency adjustment (e.g., a core doppler compensation)) to the RACH message(s) 215 if the RACH resources for the RACH messages are from the GNSS-less pool. In some examples, the one or more offsets may be based on the NTN entity 225 (e.g., or another network entity 105) indicating one or more common offsets (e.g., common for the cell 235, a common timing advance, a common frequency adjustment) for UE 115 in the GNSS-less mode. Additionally, the NTN entity 225 may indicate one or more orders of derivative of the common offsets (e.g., a first derivative of timing advance (e.g., the frequency adjustment), a second derivative of the timing advance (e.g., a timing advance drift rate)), a validity indicator associated with the common offsets indicating a duration for which the common offsets, the derivatives, or both, are valid (e.g., a duration T, where, if the UE 115 obtains the one or more common offsets and derivatives at time t, they are valid until t+T).

In some examples, the one or more offsets may be based on the NTN entity 225 indicating a reference location 250 (e.g., reference coordinates, indicated in the control information 210). For example, the UE 115 may compute the common timing advance and the common frequency adjustment as if the UE 115 were at the reference location 250. In some examples, the NTN entity 225 may also indicate a change in the reference location 250 over time (e.g., a location drift of the reference location 250, location drift rate of the reference location 250), a validity indicator associated with the reference location 250 (e.g., as described herein), or both.

In some examples, the one or more offsets may be based on previous timing advance command, frequency adjustment command, or both, received or buffered in a memory at the UE 115. For example, if the UE 115 has accumulated timing advance command, frequency adjustment command, or both, in the last T units of time, the UE 115 may derive the one or more offsets based on the accumulated timing advance command, frequency adjustment command, or both.

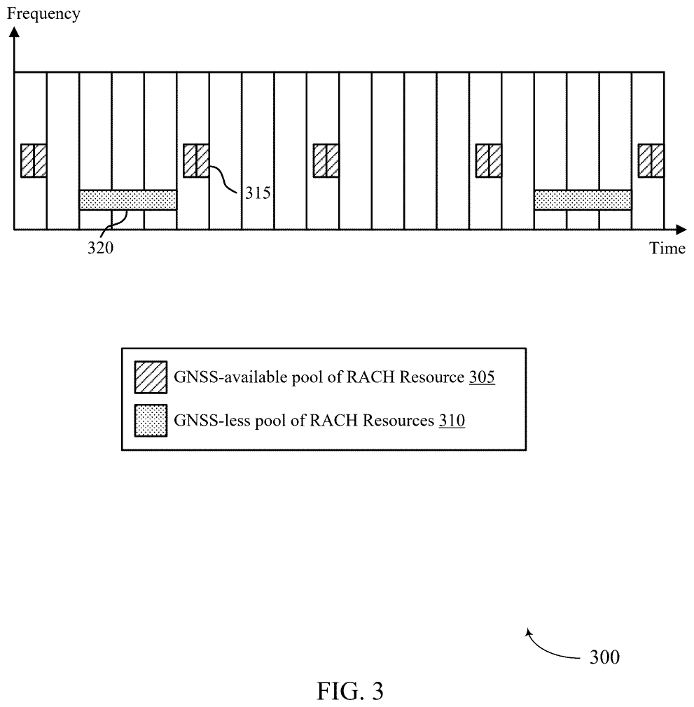

In some cases, a UE 115 may use a RACH resource pool associated with a GNSS state in which the UE 115 is not. For example, the UE 115-a may be in the GNSS-available state. If a RACH procedure of the UE 115-a using resources from the GNSS-available pool is unsuccessful, the UE 115-a may reattempt the RACH procedure again using a RACH resource from the GSS-less pool before declaring a RACH failure. In some cases, the difference between the RACH resource pools (e.g., as described herein with respect to FIG. 3) may cause the reattempted RACH procedure to be successful at the UE 115-a in spite of the UE 115-a being in the GNSS-available mode. In some cases, if the UE 115-a uses a RACH resource from the GNSS-less pool for a RACH procedure, the UE 115-a may not use the one or more common offsets, but may instead apply one or more UE adjusted offsets (e.g., time frequency compensation) computed at the UE 115-a based on measuring (e.g., passively, actively) the GNSS signaling 220 from the GNSS entity 230.

In some examples, the control information 210 (e.g., a SIB) may include other information in addition to the RACH resource pools. For example, the control information 210 may include a flag (e.g., a field in the SIB) to indicate whether the cell 235 of the NTN entity 225 supports UEs 115 in the GNSS-less state (e.g., such as the UE 115-b). If the flag is unset (e.g., is a “0”), the UE 115-b (e.g., a UE 115 in the GNSS-less state) may not attempt to perform the RACH procedure in the cell 235. If this flag is set (e.g., is a “1”), then the UE 115-b (e.g., and the UE 115-a) may attempt to perform the RACH procedure based on the respective GNSS state of the UE 115.

FIG. 3 shows an example of a resource diagram 300 that supports state-based RACH resource for wireless communication in accordance with one or more aspects of the present disclosure. In some cases, aspects of the resource diagram 300 may implement or be implemented by aspects of FIGS. 1 and 2. For example, the resource diagram 300 may illustrate resources included in the GNSS-available pool of RACH resources 305 (e.g., the first pool of RACH resources) and the GNSS-less pool of RACH resources 310 (e.g., the second pool of RACH resources), as described herein with respect to FIGS. 1 and 2. In some aspects, the GNSS-less pool of RACH resources 310 may include RACH resources with one or more distinct or different characteristics from RACH resources included in the GNSS-available pool of RACH resources 305.

In some cases, the two pools of RACH resources may be indicated by one or more parameter value in two respective information elements. For example, the two information elements may be in the control information 210 described in FIG. 2. In some examples, the parameter values in the two information elements may define the RACH resources in the two pool of RACH resources. For example, an RO 315 (e.g., along with other aspects of a RACH resource, including a RACH preamble) may fall within (e.g., be according to) the parameter values indicated by the information element associated with the GNSS-available pool of RACH resources 305, and the RO 320 (e.g., along with other aspects of a RACH resources, including a RACH preamble) may fall within (e.g., be according to) the parameter values indicated by the information element associated with the GNSS-less pool of RACH resources 310.

The resource diagram may illustrate relative resources for an RO 315 from the GNSS-available pool of RACH resources 305 and an RO 320 from the GNSS-less pool of RACH resources 310. A horizontal axis of the resource diagram 300 may represent one or more time resources, such as slots, frames, or subframes, and the vertical axis of the resource diagram 300 may represent frequency resources. In some examples, the GNSS-less pool of RACH resources 310 may include longer RACH preambles, longer ROs 320, or both, than the RACH preambles, ROs 315, or both, respectively, included in the GNSS-available pool of RACH resources 305. Such increased length in time and preamble resources may allow for a larger error in the estimation of offsets (e.g., the timing advance) by UEs 115 in the GNSS-less mode while having a successful RACH procedure. Additionally, or alternatively, the GNSS-less pool of RACH resources 310 may include RACH preambles (e.g., not shown) having a format associated with a greater quantity of propagation paths than RACH preambles included in the GNSS-available pool of RACH resources 305. In some cases, such increased quantities of propagation paths may allow the UEs 115 in the GNSS-less state to better calculate or approximate the frequency adjustment (e.g., due to the Doppler effect, for example). Thus, the RACH resource pools described herein may allow for improved connectivity of UEs 115 in the GNSS-available state, the GNSS-less state, or both.

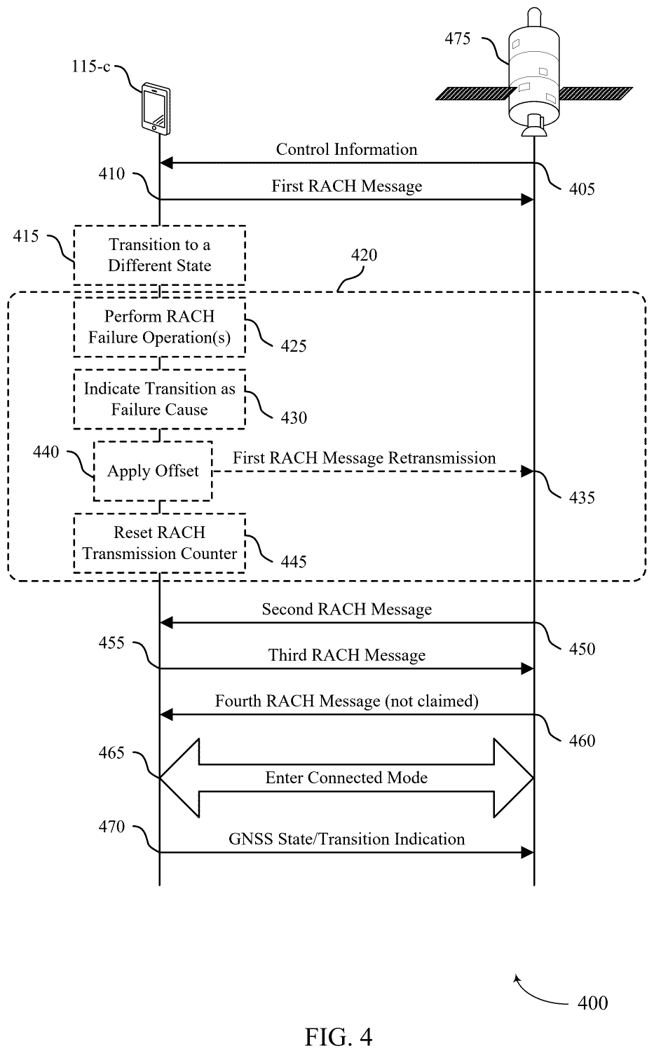

FIG. 4 shows an example of a process flow 400 that supports state-based RACH resource for wireless communication in accordance with one or more aspects of the present disclosure. In some cases, aspects of the process flow 400 may implement or be implemented by aspects of FIGS. 1-3. For example, the process flow may include a UE 115-c and an NTN entity 475, which may be examples of the UEs 115 and the NTN entities (e.g., such as the NTN entity 225) as described herein with respect to FIGS. 1-3. In some aspects, the UE 115-c may receive control information indicating the GNSS-available pool and the GNSS-less pool, and may communicate one or more RACH messages with the NTN entity 475 based on the control information, a GNSS state of the UE 115-c, or both.

In the following description of process flow 400, the operations may be performed in a different order than the order shown, or other operations may be added or removed from the process flow 400. For example, some operations may also be left out of process flow 400, may be performed in different orders or at different times, or other operations may be added to process flow 400. Although the UE 115-c and the NTN entity 475 are shown performing the operations of process flow 400, some aspects of some operations may also be performed by one or more other wireless devices or network devices. For example, one or more operations performed by the NTN entity 475 (e.g., such as transmitting the control information to the UE 115-c) may be performed by a network entity 105 (e.g., as described herein with respect to FIGS. 1-3).

At 405, the UE 115-c may receive (e.g., from the NTN entity 475, a network entity 105) control information that may indicate the GNSS-available pool (e.g., a first pool of RACH resources for UEs in the GNSS-available state) and the GNSS-less pool (e.g., a second pool of RACH resources for UEs in the GNSS-less state). For example, the control information may be one or more control messages that include an information element for each pool of RACH resources, where each information element may indicate parameter values for multiple parameters. In some examples, RACH resources in (e.g., indicated by, derived from) the GNSS-available pool may be in accordance with (e.g., may be defined by) a first set of parameter values (e.g., indicated in a first information element) and RACH resources in the GNSS-less pool may be in accordance with a second set of parameter values (e.g., indicated in a second information element).

In some cases, the GNSS-available pool and the GNSS-less pool may share one or more common parameter values. For example, a first subset of the second set of parameter values (e.g., defining the GNSS-less pool) may be identical to a first subset of the first set of parameter values (e.g., defining the GNSS-available pool), and a second subset of the second set of parameter values may be different than a second subset of the first set of parameter values. That is, the GNSS-available pool may indicate one or more common parameter values, or parameter values that may be common for a RACH resource in the GNSS-available pool and the GNSS-less pool (e.g., a RACH resource for UEs in the GNSS-available state and for UEs in the GNSS-less state). In some examples, to indicate the RACH resources in the GNSS-available pool, the control information may indicate each of the first set of parameter values (e.g., a value for each parameter, the common parameter values and the parameter values specific to the GNSS-available pool), and to indicate the RACH resources in the GNSS-less pool, the control information may indicate the second subset of the second set of parameter values (e.g., the parameter values specific to the GNSS-less pool) and not the first subset of the second set of parameter values (e.g., not the common parameter values).

In some examples, the GNSS-less pool may include RACH resources with one or more different characteristics than the RACH resources included in the GNSS-available pool. For example, the GNSS-less pool may include longer RACH preambles (e.g., sequences) than the GNSS-available pool, longer ROs than the GNSS-available pool, RACH preambles having a format associated with a greater quantity of propagation paths than the GNSS-available pool, or any combination thereof.

The control information may include one or more other indications in addition to the pools of RACH resources. For example, the control information may include a flag indicating whether a cell (e.g., the cell 235) associated with the control information supports RACH procedures for UEs in the GNSS-less state, the GNSS-available state, both, or each exclusively.

At 410, the UE 115-c may transmit, to the NTN entity 475, a first RACH message (e.g., Msg1,) using a first RACH resource based on the GNSS state of the UE 115-c and the pools indicated in the control information. For example, whether the first RACH resource is from the GNSS-available pool or the GNSS-less pool may be based on a GNSS state of the UE 115-c. In some cases, the GNSS-available state (e.g., a first state with respect to the GNSS) may include the UE 115-c being able to obtain its location using the GNSS, being capable of using the GNSS, or both. Additionally, or alternatively, the GNSS-less state (e.g., a second state with respect to the GNSS) may include the UE 115-c being unable to obtain its location using the GNSS, being incapable of using the GNSS, or both.

The UE 115-c may enter the GNSS-less state in response to one or more causes. For example, the UE 115-c may enter the GNSS-less state based on being incapable of using the GNSS, an expiration of a GNSS validity timer (e.g., a duration during which location information determined using the GNSS is valid), a resource selection probability factor indicated in the control information (e.g., as described with respect to FIG. 2), or any combination thereof. The first RACH resource may be from the GNSS-less pool based on the UE being in the GNSS-less state.

In some cases, the UE 115-c may derive one or more offsets (e.g., a timing advance, a frequency adjustment, both) to apply to the first RACH message. For example, based on the first RACH resource being from the GNSS-less pool, the one or more offsets may be based on a common timing advance for UEs in the GNSS-less state, a common frequency adjustment for UEs in the GNSS-less state, one or more derivatives of the common timing advance, one or more derivatives of the common frequency adjustment, a validity duration associated with the common timing advance or the common frequency adjustment, or any combination thereof. Additionally, or alternatively, the one or more offsets may be based on a reference location for UEs in the GNSS-less state (e.g., where the UE 115-c may calculate the one or more offsets as if it were at the reference location), a location drift associated with the reference location, a location drift rate associated with the reference location, a validity duration associated with the reference location, or any combination thereof. Additionally, or alternatively, the one or more offsets may be based on one or more timing advance commands or frequency adjustment commands received by the UE 115-c within a duration of time (e.g., a previous duration of time), stored in a buffer at the UE 115-c, or both.

At 415, in some cases, the UE 115-c may transition, during or after transmission of the first RACH message (e.g., during a RACH procedure), to a different GNSS state of the UE 115-c, where the different GNSS state may be one of the GNSS-available state or the GNSS-less state.

At 420, UE 115-c may perform one or more operations (e.g., including those described at 425 through 445) based on transitioning to a different GNSS state during one or more portions of the RACH procedure (e.g., as described at 415). The one or more operations described within 420 may be performed in one or more orders or combinations, as described herein.

At 425, based on transitioning to a different GNSS state (e.g., from the GNSS-available state to the GNSS-less state), the UE 115-c may perform one or more RACH failure operations. For example, the control information may indicate one or more parameter values associated with handling a RACH failure, and the UE 115-c may perform one or more RACH failure operations based on the one or more parameter values and the transition. At 430, (e.g., as part of or based on the one or more RACH failure operations), the UE 115-c may indicate the transition to the different GNSS state as a cause of RACH failure to an upper layer of the UE.

At 435, the UE 115-c may retransmit the first RACH message (e.g., a second RACH message, transmit a retransmission of the first RACH message, retransmitting Msg1). In some examples, the UE 115-c may use a second RACH resource from a different RACH resource pool (e.g., the pool associated with the different GNSS-state) to retransmit the first RACH message, where whether the different RACH resource pool is the GNSS-available pool or the GNSS-less pool is based on the different GNSS state. Alternatively, the UE 115-c may retransmit the first RACH message using a second RACH resource from a same pool of RACH resources as the first RACH resource.

As one example, the first RACH resource may be from the GNSS-available pool based on the GNSS state of the UE being the GNSS-available state when the UE 115-c transmits the first RACH message. In such an example (e.g., if the UE 115-c transitions to the different GNSS state during the RACH procedure), the UE 115-c may transmit, based on failing to receive a second RACH message (e.g., RAR message) in response to the first RACH message, a retransmission of the first RACH message (e.g., a third RACH message, retransmitting Msg1) using a second RACH resource from the GNSS-less pool despite being in the GNSS-available state. In such cases (e.g., at 440), the UE 115-c may apply one or more offsets (e.g., a timing advance, a frequency adjustment, both) to the first RACH message retransmission that are based on measurements of one or more signals from the GNSS (e.g., such as the GNSS signaling 220 of FIG. 2) since the UE is in the GNSS-available state but using a GNSS-less resource.

At 445, the UE 115-c may reset a RACH transmission counter based on the second RACH resource. For example, if the second RACH resource is from a different pool of RACH resources than the first RACH resource, the UE 115-c may reset the RACH transmission counter to give the UE 115-c more attempts to successfully perform the RACH procedure using the second RACH resource.

At 450, the UE 115-c may receive, in response to the first RACH message, a second RACH message (e.g., Msg2). In some cases, the second RACH message may indicate information associated with an uplink frequency adjustment for a third RACH message (e.g., Msg3). For example, if the UE 115-c transmits the first RACH message using the GNSS-less pool of RACH resources, the second RACH message may indicate the information associated with the uplink frequency adjustment.

At 455, the UE 115-c may transmit, in response to the second RACH message, a third RACH message. In some cases, if the UE 115-c transitioned to a different GNSS state during the RACH procedure, the third RACH message may indicate the transition, the different GNSS state, or both, to the NTN entity 475. Thus, further communications after the RACH procedure may be based on the different GNSS-state.

At 460, the UE 115-c may receive, in response to the third RACH message, a fourth RACH message (e.g., Msg4). In some examples, receiving the fourth RACH message may be an end of the RACH procedure, or may allow the UE 115-c to enter a connected mode with the NTN entity 475 at 465 (e.g., based on transmitting the first RACH message).

At 470, the UE 115-c may transmit, to the NTN entity 475 after entering the connected mode (e.g., after establishing a wireless connection), an indication of the transition, the different GNSS state, or both (e.g., if the UE 115-c transitioned to a different GNSS state at 415). In some cases, the UE 115-c may transmit the indication via signaling that is dedicated to indicating transitions of GNSS state while in the connected mode.

Thus, according to the techniques here, the UE 115-c may perform a RACH procedure with the NTN entity 475 based on receiving an indication of the GNSS-available pool of RACH resources and the GNSS-less pool of RACH resources and the GNSS state of the UE 115-c. Such techniques may allow the UE 115-c to connect with the NTN entity 475 and stay connected with the NTN entity 475 irrespective of the GNSS state of the UE 115-c, increasing robustness and signal quality in a wireless communications system that includes the UE 115-c and the NTN entity 475.

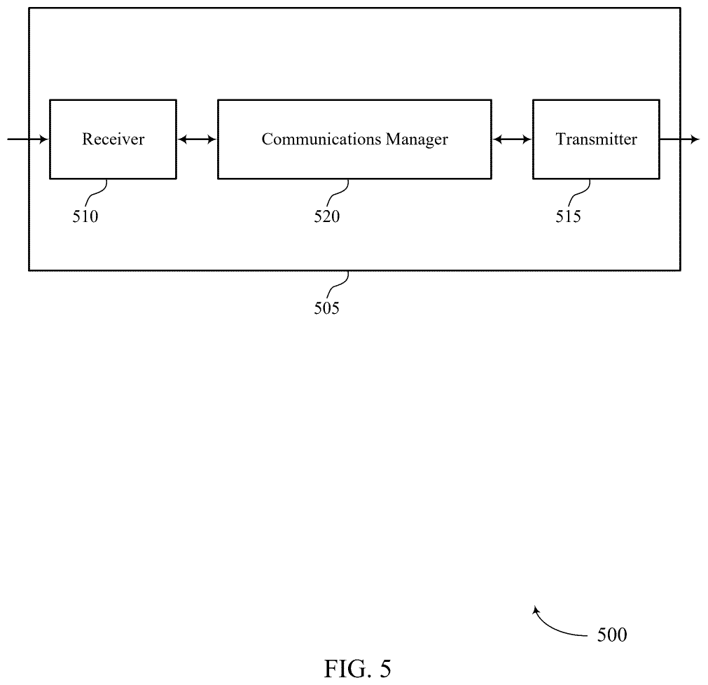

FIG. 5 shows a block diagram 500 of a device 505 that supports state-based RACH resource for wireless communication in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to state-based RACH resource for wireless communication). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to state-based RACH resource for wireless communication). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of state-based RACH resource for wireless communication as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may be configured to receive or transmit messages or other signaling as described herein via a transceiver 815. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving control information that indicates a first pool of RACH resources for UEs in a first state with respect to a navigation satellite system and a second pool of RACH resources for UEs in a second state with respect to the navigation satellite system, wherein at least one random access resource in the first pool of random access resources is not included in the second pool of random access resources or at least one random access resource in the second pool of random access resources is not included in the first pool of random access resources. The communications manager 520 is capable of, configured to, or operable to support a means for transmitting a first RACH message using a first RACH resource, where whether the first RACH resource is from the first pool of RACH resources or the second pool of RACH resources is based on a state of the UE with respect to the navigation satellite system.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for more efficient utilization of communication resources. For example, a UE 115 implementing the techniques described herein may experience more RACH procedure success with respect to NTNs regardless of the GNSS state of the UE 115. More RACH procedure success may reduce RACH procedure attempts, utilizing less resources to connect to the NTN.

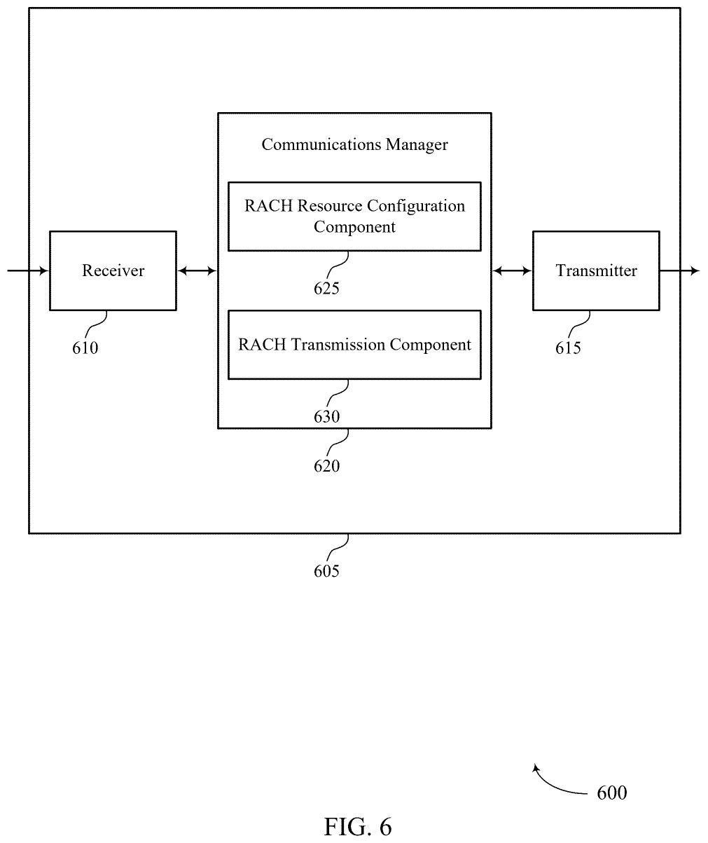

FIG. 6 shows a block diagram 600 of a device 605 that supports state-based RACH resource for wireless communication in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to state-based RACH resource for wireless communication). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to state-based RACH resource for wireless communication). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of state-based RACH resource for wireless communication as described herein. For example, the communications manager 620 may include a RACH resource configuration component 625 a RACH transmission component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may be configured to receive or transmit messages or other signaling as described herein via the transceiver 815. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The RACH resource configuration component 625 is capable of, configured to, or operable to support a means for receiving control information that indicates a first pool of RACH resources for UEs in a first state with respect to a navigation satellite system and a second pool of RACH resources for UEs in a second state with respect to the navigation satellite system, wherein at least one random access resource in the first pool of random access resources is not included in the second pool of random access resources or at least one random access resource in the second pool of random access resources is not included in the first pool of random access resources. The RACH transmission component 630 is capable of, configured to, or operable to support a means for transmitting a first RACH message using a first RACH resource, where whether the first RACH resource is from the first pool of RACH resources or the second pool of RACH resources is based on a state of the UE with respect to the navigation satellite system.

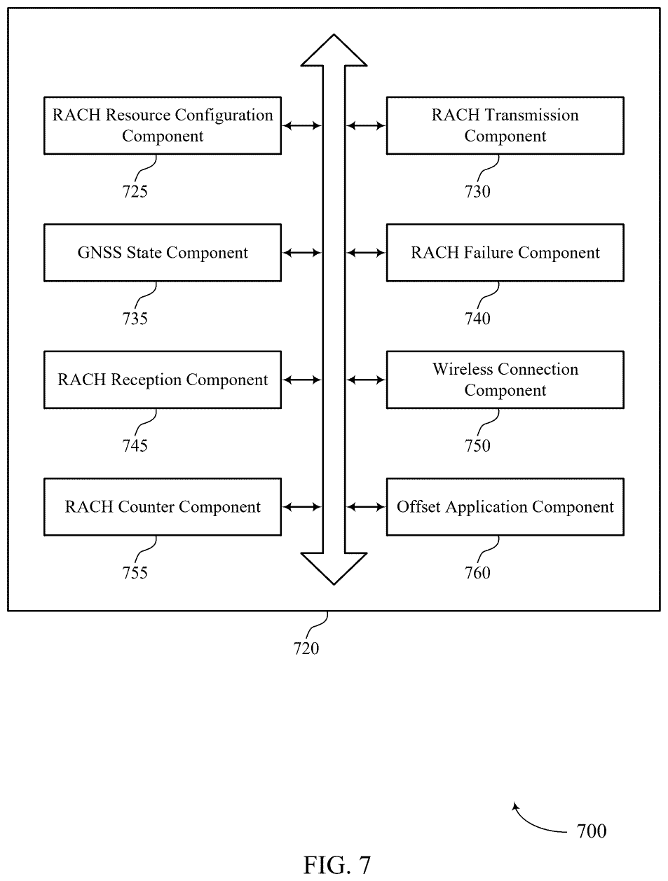

FIG. 7 shows a block diagram 700 of a communications manager 720 that supports state-based RACH resource for wireless communication in accordance with one or more aspects of the present disclosure. The communications manager 720 may be an example of aspects of a communications manager 520, a communications manager 620, or both, as described herein. The communications manager 720, or various components thereof, may be an example of means for performing various aspects of state-based RACH resource for wireless communication as described herein. For example, the communications manager 720 may include a RACH resource configuration component 725, a RACH transmission component 730, an GNSS state component 735, a RACH failure component 740, a RACH reception component 745, a wireless connection component 750, a RACH counter component 755, an offset application component 760, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The RACH resource configuration component 725 is capable of, configured to, or operable to support a means for receiving control information that indicates a first pool of RACH resources for UEs in a first state with respect to a navigation satellite system and a second pool of RACH resources for UEs in a second state with respect to the navigation satellite system, wherein at least one random access resource in the first pool of random access resources is not included in the second pool of random access resources or at least one random access resource in the second pool of random access resources is not included in the first pool of random access resources. The RACH transmission component 730 is capable of, configured to, or operable to support a means for transmitting a first RACH message using a first RACH resource, where whether the first RACH resource is from the first pool of RACH resources or the second pool of RACH resources is based on a state of the UE with respect to the navigation satellite system.

In some examples, RACH resources in the first pool of RACH resources are in accordance with a first set of parameter values and RACH resources in the second pool of RACH resources are in accordance with a second set of parameter values, wherein the first set of parameter values and the second set of parameter values share a common set of parameter values. In some examples, to indicate the RACH resources in the first pool, the control information indicates each of the first set of parameter values including the common set of parameter values. In some examples, to indicate the RACH resources in the second pool, the control information indicates each of the second set of parameter values excluding the common set of parameter values.

In some examples, the first RACH resource is from the second pool of RACH resources based on the state of the UE with respect to the navigation satellite system comprising the UE being unable to obtain its location using the navigation satellite system, the UE being incapable of using the navigation satellite system, an expiration of a navigation satellite system validity timer, a resource selection probability factor indicated in the control information, or any combination thereof.

In some examples, the second pool of RACH resources includes longer RACH preambles than the first pool of RACH resources, longer RACH occasions than the first pool of RACH resources, RACH preambles having a format associated with a greater quantity of propagation paths than the first pool of RACH resources, or any combination thereof.

In some examples, the RACH transmission component 730 is capable of, configured to, or operable to support a means for transmitting a second RACH message using a second RACH resource from a different pool of RACH resources, where whether the different pool of RACH resources is the first pool of RACH resources or the second pool of RACH resources is based on whether the UE has transitioned, during or after transmission of the first random access message, from the first state to the second state or from the second state to the first state.

In some examples, the RACH counter component 755 is capable of, configured to, or operable to support a means for resetting a RACH transmission counter based on the second RACH resource being from the different pool of RACH resources than the first RACH resource.

In some examples, the RACH failure component 740 is capable of, configured to, or operable to support a means for performing one or more RACH failure operations based on a transition of the UE, during or after transmission of the first RACH message, to a different state of the UE with respect to the navigation satellite system.

In some examples, the GNSS state component 735 is capable of, configured to, or operable to support a means for indicating the transition of the UE to the different state as a cause of RACH failure to an upper layer of the UE based on performing the one or more RACH failure operations.

In some examples, the RACH transmission component 730 is capable of, configured to, or operable to support a means for transmitting a second RACH message using a second RACH resource, where the second RACH resource and the first RACH resource are from a same pool of RACH resources despite a transition of the UE, during or after transmission of the first random access message, to a different state of the UE with respect to the navigation satellite system.

In some examples, the RACH reception component 745 is capable of, configured to, or operable to support a means for receiving, in response to the first RACH message, a RACH response message indicating information associated with an uplink frequency adjustment for a third RACH message.

In some examples, the RACH reception component 745 is capable of, configured to, or operable to support a means for receiving, in response to the first RACH message, a RACH response message. In some examples, the RACH transmission component 730 is capable of, configured to, or operable to support a means for transmitting, in response to the RACH response message, a third RACH message that indicates a transition of the UE to a different state of the UE with respect to the navigation satellite system, the different state, or both.

In some examples, the wireless connection component 750 is capable of, configured to, or operable to support a means for entering a connected mode based on transmitting the first RACH message. In some examples, the GNSS state component 735 is capable of, configured to, or operable to support a means for transmitting, after entering the connected mode, an indication of a transition of the UE, during or after transmission of the first random access message, to a different state of the UE with respect to the navigation satellite system, the different state, or both.

In some examples, based on the first RACH resource being from the second pool of RACH resources, a timing advance, frequency adjustment, or any combination thereof associated with the first RACH message is based on a common timing advance for UEs in the second state, a common frequency adjustment for UEs in the second state, one or more derivatives of the common timing advance, one or more derivatives of the common frequency adjustment, a validity duration associated with the common timing advance or the common frequency adjustment, a reference location for UEs in the second state, a location drift associated with the reference location, a location drift rate associated with the reference location, a validity duration associated with the reference location, one or more timing advance commands or frequency adjustment commands received by the UE within a duration of time or stored in a buffer at the UE, or any combination thereof.

In some examples, the first RACH resource is from the first pool of RACH resources based on the state of the UE being the first state, and the RACH transmission component 730 is capable of, configured to, or operable to support a means for transmitting, based on failing to receive a RACH response message in response to the first RACH message, a third RACH message using a second RACH resource from the second pool of RACH resources despite being in the first state.

In some examples, the offset application component 760 is capable of, configured to, or operable to support a means for applying a timing advance, a frequency adjustment, or both, to the third RACH message based on measurements of one or more signals from the navigation satellite system.

In some examples, the control information includes a flag indicating whether a cell associated with the control information supports RACH procedures for UEs in the second state with respect to the navigation satellite system.

In some examples, the first state with respect to the navigation satellite system includes the UE being able to obtain its location using the navigation satellite system, being capable of using the navigation satellite system, or both. In some examples, the second state with respect to the navigation satellite system includes the UE being unable to obtain its location using the navigation satellite system, being incapable of using the navigation satellite system, or both.

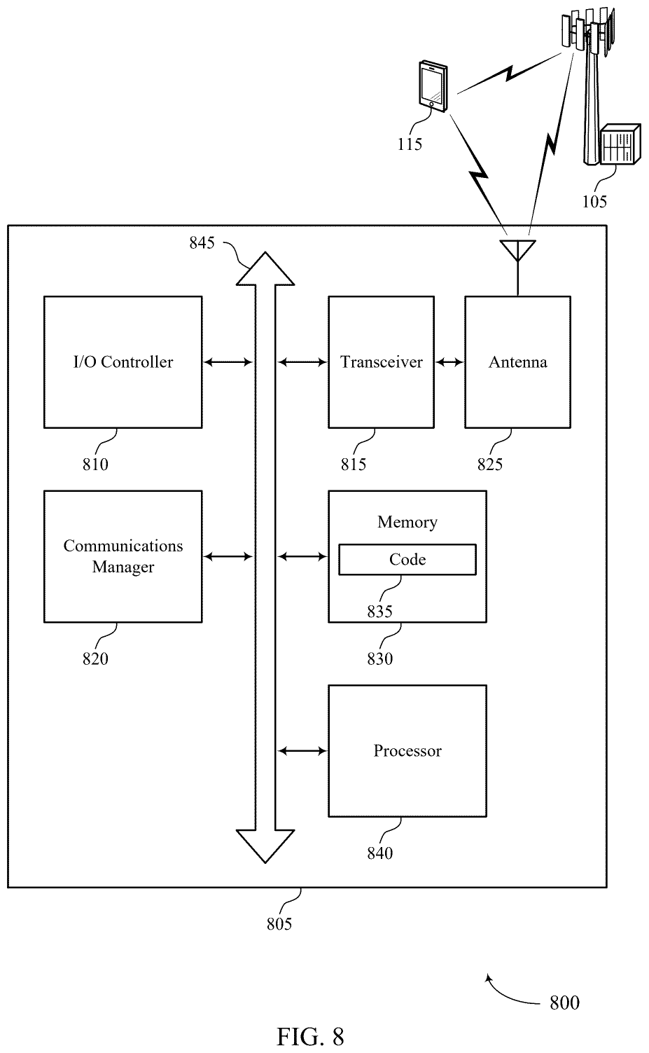

FIG. 8 shows a diagram of a system 800 including a device 805 that supports state-based RACH resource for wireless communication in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include RACH memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting state-based RACH resource for wireless communication). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving control information that indicates a first pool of RACH resources for UEs in a first state with respect to a navigation satellite system and a second pool of RACH resources for UEs in a second state with respect to the navigation satellite system, wherein at least one random access resource in the first pool of random access resources is not included in the second pool of random access resources or at least one random access resource in the second pool of random access resources is not included in the first pool of random access resources. The communications manager 820 is capable of, configured to, or operable to support a means for transmitting a first RACH message using a first RACH resource, where whether the first RACH resource is from the first pool of RACH resources or the second pool of RACH resources is based on a state of the UE with respect to the navigation satellite system.

By including or configuring the communications manager 820 in accordance with examples as described herein, the device 805 may support techniques for improved communication reliability. For example, UEs 115 implementing these techniques may perform RACH procedures using RACH resources based on the GNSS state in which the UEs 115 are. As such, the UEs 115 may have greater success in connecting with NTNs in the RACH procedures, allowing for improved communication reliability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of state-based RACH resource for wireless communication as described herein, or the at least one processor 840 and the at least one memory 830 may be otherwise configured to, individually or collectively, perform or support such operations.

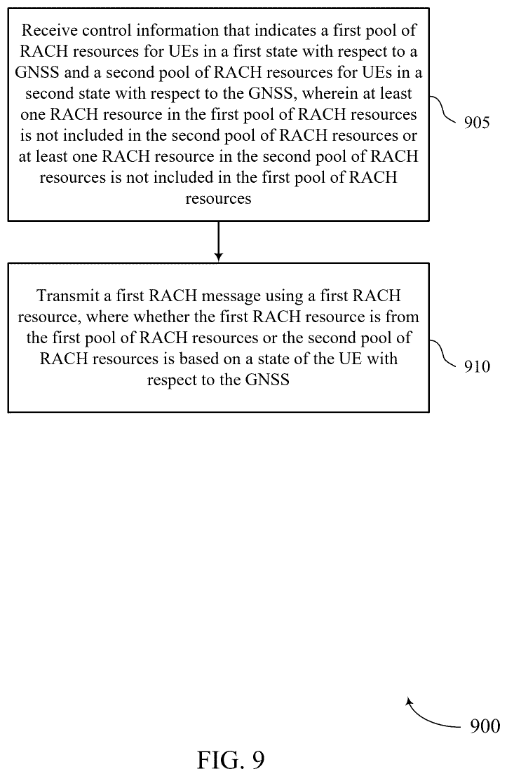

FIG. 9 shows a flowchart illustrating a method 900 that supports state-based RACH resource for wireless communication in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving control information that indicates a first pool of RACH resources for UEs in a first state with respect to a navigation satellite system and a second pool of RACH resources for UEs in a second state with respect to the navigation satellite system, wherein at least one RACH resource in the first pool of RACH resources is not included in the second pool of RACH resources or at least one RACH resource in the second pool of RACH resources is not included in the first pool of RACH resources. The operations of 905 may be performed in accordance with examples as disclosed herein. In some examples, aspects of the operations of 905 may be performed by a RACH resource configuration component 725 as described with reference to FIG. 7. Additionally, or alternatively, means for performing 905 may, but not necessarily, include, for example, antenna 825, transceiver 815, communications manager 820, memory 830 (including code 835), processor 840 and/or bus 845.

At 910, the method may include transmitting a first RACH message using a first RACH resource, where whether the first RACH resource is from the first pool of RACH resources or the second pool of RACH resources is based on a state of the UE with respect to the navigation satellite system. The operations of 910 may be performed in accordance with examples as disclosed herein. In some examples, aspects of the operations of 910 may be performed by a RACH transmission component 730 as described with reference to FIG. 7. Additionally, or alternatively, means for performing 910 may, but not necessarily, include, for example, antenna 825, transceiver 815, communications manager 820, memory 830 (including code 835), processor 840 and/or bus 845.

The following provides an overview of aspects of the present disclosure:

Aspect 1: A method for wireless communications at a UE, comprising: receiving control information that indicates a first pool of RACH resources for UEs in a first state with respect to a GNSS and a second pool of RACH resources for UEs in a second state with respect to the GNSS, wherein at least one RACH resource in the first pool of RACH resources is not included in the second pool of RACH resources or at least one RACH resource in the second pool of RACH resources is not included in the first pool of RACH resources; and transmitting a first RACH message using a first RACH resource, wherein whether the first RACH resource is from the first pool of RACH resources or the second pool of RACH resources is based at least in part on a state of the UE with respect to the GNSS.

Aspect 2: The method of aspect 1, wherein RACH resources in the first pool of RACH resources are in accordance with a first set of parameter values and RACH resources in the second pool of RACH resources are in accordance with a second set of parameter values, the first set of parameter values and the second set of parameter values share a common set of parameter values, to indicate the RACH resources in the first pool, the control information indicates each of the first set of parameter values including the common set of parameter values, and to indicate the RACH resources in the second pool, the control information indicates each of the second set of parameter values excluding the common set of parameter values.

Aspect 3: The method of any of aspects 1 through 2 wherein the first RACH resource is from the second pool of RACH resources based at least in part on the state of the UE with respect to the GNSS comprising the UE being unable to obtain its location using the GNSS, the UE being incapable of using the GNSS, an expiration of a GNSS validity timer, a resource selection probability factor indicated in the control information, or any combination thereof.

Aspect 4: The method of any of aspects 1 through 3, wherein the second pool of RACH resources comprises longer RACH preambles than the first pool of RACH resources, longer RACH occasions than the first pool of RACH resources, RACH preambles having a format associated with a greater quantity of propagation paths than the first pool of RACH resources, or any combination thereof.

Aspect 5: The method of any of aspects 1 through 4 further comprising: transmitting a second RACH message using a second RACH resource from a different pool of RACH resources, wherein whether the different pool of RACH resources is the first pool of RACH resources or the second pool of RACH resources is based at least in part on whether the UE has transitioned, during or after transmission of the first RACH message, from the first state to the second state or from the second state to the first state.

Aspect 6: The method of aspect 5, further comprising: resetting a RACH transmission counter based at least in part on the second RACH resource being from the different pool of RACH resources than the first RACH resource.

Aspect 7: The method of any of aspects 1 through 6, further comprising: performing one or more RACH failure operations based at least in part on a transition of the UE, during or after transmission of the first RACH message, to a different state of the UE with respect to the GNSS.

Aspect 8: The method of aspect 7, further comprising: indicating the transition of the UE to the different state as a cause of RACH failure to an upper layer of the UE based at least in part on performing the one or more RACH failure operations.

Aspect 9: The method of any of aspects 1 through 8, further comprising: transmitting a second RACH message using a second RACH resource, wherein the second RACH resource and the first RACH resource are from a same pool of RACH resources despite a transition of the UE, during or after transmission of the first RACH message, to a different state of the UE with respect to the GNSS.

Aspect 10: The method of any of aspects 1 through 9 further comprising: receiving, in response to the first RACH message, a RACH response message indicating information associated with an uplink frequency adjustment for a third RACH message.

Aspect 11: The method of any of aspects 1 through 10 further comprising: receiving, in response to the first RACH message, a RACH response message; and transmitting, in response to the RACH response message, a third RACH message that indicates a transition of the UE to a different state of the UE with respect to the GNSS, the different state, or both.

Aspect 12: The method of any of aspects 1 through 11, further comprising: entering a connected mode based at least in part on transmitting the first RACH message; and transmit, after entering the connected mode, an indication of a transition of the UE, during or after transmission of the first RACH message, to a different state of the UE with respect to the GNSS, the different state, or both.

Aspect 13: The method of any of aspects 1 through 12, wherein based at least in part on the first RACH resource being from the second pool of RACH resources, a timing advance, frequency adjustment, or any combination thereof associated with the first RACH message is based at least in part on a common timing advance for UEs in the second state, a common frequency adjustment for UEs in the second state, one or more derivatives of the common timing advance, one or more derivatives of the common frequency adjustment, a validity duration associated with the common timing advance or the common frequency adjustment, a reference location for UEs in the second state, a location drift associated with the reference location, a location drift rate associated with the reference location, a validity duration associated with the reference location, one or more timing advance commands or frequency adjustment commands received by the UE within a duration of time or stored in a buffer at the UE, or any combination thereof.

Aspect 14: The method of any of aspects 1, 2, and 4 through 13, wherein the first RACH resource is from the first pool of RACH resources based at least in part on the state of the UE being the first state, the method further comprising: transmitting, based at least in part on failing to receive a RACH response message in response to the first RACH message, a third RACH message using a second RACH resource from the second pool of RACH resources despite being in the first state.

Aspect 15: The method of aspect 14, further comprising: applying a timing advance, a frequency adjustment, or both, to the third RACH message based at least in part on measurements of one or more signals from the GNSS.

Aspect 16: The method of any of aspects 1 through 15, wherein the control information comprises a flag indicating whether a cell associated with the control information supports RACH procedures for UEs in the second state with respect to the GNSS.

Aspect 17: The method of any of aspects 1 through 16, wherein the first state with respect to the GNSS comprises the UE being able to obtain its location using the GNSS, being capable of using the GNSS, or both, and the second state with respect to the GNSS comprises the UE being unable to obtain its location using the GNSS, being incapable of using the GNSS, or both.

Aspect 18: A UE for wireless communications, comprising one or more memories storing processor-executable code, a transceiver, and one or more processors coupled with the one or more memories and the transceiver, the one or more processors individually or collectively operable to execute the code to cause the UE to perform a method of any of aspects 1 through 17.

Aspect 19: A UE for wireless communications, comprising at least one means for performing a method of any of aspects 1 through 17.

Aspect 20: A non-transitory computer-readable medium storing code for wireless communications, the code comprising instructions executable by one or more processors to perform a method of any of aspects 1 through 17.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code;
a transceiver; and
one or more processors coupled with the one or more memories and the transceiver, the one or more processors individually or collectively operable to execute the code to cause the UE to:
receive, via the transceiver, control information that indicates a first pool of random access resources for UEs in a first state with respect to a navigation satellite system and a second pool of random access resources for UEs in a second state with respect to the navigation satellite system, wherein at least one random access resource in the first pool of random access resources is not included in the second pool of random access resources or at least one random access resource in the second pool of random access resources is not included in the first pool of random access resources; and
transmit, via the transceiver, a first random access message using a first random access resource, wherein whether the first random access resource is from the first pool of random access resources or the second pool of random access resources is based at least in part on a state of the UE with respect to the navigation satellite system.

2. The UE of claim 1, wherein:
random access resources in the first pool of random access resources are in accordance with a first set of parameter values and random access resources in the second pool of random access resources are in accordance with a second set of parameter values, wherein the first set of parameter values and the second set of parameter values share a common set of parameter values,
to indicate the random access resources in the first pool, the control information indicates each of the first set of parameter values including the common set of parameter values, and
to indicate the random access resources in the second pool, the control information indicates each of the second set of parameter values excluding the common set of parameter values.

3. The UE of claim 1, wherein the one or more processors are individually or collectively further operable to execute the code to cause the UE to:
transmit, via the transceiver, a second random access message using a second random access resource from a different pool of random access resources, wherein whether the different pool of random access resources is the first pool of random access resources or the second pool of random access resources is based at least in part on whether the UE has transitioned, during or after transmission of the first random access message, from the first state to the second state or from the second state to the first state.

4. The UE of claim 3, wherein the one or more processors are individually or collectively further operable to execute the code to cause the UE to:
reset a random access transmission counter based at least in part on the second random access resource being from the different pool of random access resources than the first random access resource.

5. The UE of claim 1, wherein the one or more processors are individually or collectively further operable to execute the code to cause the UE to:
perform one or more random access failure operations based at least in part on a transition of the UE, during or after transmission of the first random access message, to a different state of the UE with respect to the navigation satellite system.

6. The UE of claim 5, wherein the one or more processors are individually or collectively further operable to execute the code to cause the UE to:
indicate the transition of the UE to the different state as a cause of random access failure to an upper layer of the UE based at least in part on performing the one or more random access failure operations.

7. The UE of claim 1, wherein the one or more processors are individually or collectively further operable to execute the code to cause the UE to:
transmit, via the transceiver, a second random access message using a second random access resource, wherein the second random access resource and the first random access resource are from a same pool of random access resources despite a transition of the UE, during or after transmission of the first random access message, to a different state of the UE with respect to the navigation satellite system.

8. The UE of claim 1, wherein the one or more processors are individually or collectively further operable to execute the code to cause the UE to:
receive, via the transceiver and in response to the first random access message, a random access response message indicating information associated with an uplink frequency adjustment for a third random access message.

9. The UE of claim 1, wherein the one or more processors are individually or collectively further operable to execute the code to cause the UE to:
receive, via the transceiver and in response to the first random access message, a random access response message; and
transmit, via the transceiver and in response to the random access response message, a third random access message that indicates a transition of the UE to a different state of the UE with respect to the navigation satellite system, the different state, or both.

10. The UE of claim 1, wherein the one or more processors are individually or collectively further operable to execute the code to cause the UE to:
enter a connected mode based at least in part on transmitting the first random access message; and
transmit, via the transceiver and after entering the connected mode, an indication of a transition of the UE, during or after transmission of the first random access message, to a different state of the UE with respect to the navigation satellite system, the different state, or both.

11. A method for wireless communications at a user equipment (UE), comprising:
receiving control information that indicates a first pool of random access resources for UEs in a first state with respect to a navigation satellite system and a second pool of random access resources for UEs in a second state with respect to the navigation satellite system; and
transmitting a first random access message using a first random access resource, wherein whether the first random access resource is from the first pool of random access resources or the second pool of random access resources is based at least in part on a state of the UE with respect to the navigation satellite system.

12. The UE of claim 11, wherein:
random access resources in the first pool of random access resources are in accordance with a first set of parameter values and random access resources in the second pool of random access resources are in accordance with a second set of parameter values, wherein the first set of parameter values and the second set of parameter values share a common set of parameter values,
to indicate the random access resources in the first pool, the control information indicates each of the first set of parameter values including the common set of parameter values, and
to indicate the random access resources in the second pool, the control information indicates each of the second set of parameter values excluding the common set of parameter values.

13. The method of claim 11, wherein the first random access resource is from the second pool of random access resources based at least in part on:
the state of the UE with respect to the navigation satellite system comprising the UE being unable to obtain its location using the navigation satellite system,
the UE being incapable of using the navigation satellite system,
an expiration of a navigation satellite system validity timer,
a resource selection probability factor indicated in the control information, or
any combination thereof.

14. The method of claim 11, wherein the second pool of random access resources comprises longer random access preambles than the first pool of random access resources, longer random access occasions than the first pool of random access resources, random access preambles having a format associated with a greater quantity of propagation paths than the first pool of random access resources, or any combination thereof.

15. The method of claim 11, wherein, based at least in part on the first random access resource being from the second pool of random access resources, a timing advance, frequency adjustment, or any combination thereof associated with the first random access message is based at least in part on:
a common timing advance for UEs in the second state,
a common frequency adjustment for UEs in the second state,
one or more derivatives of the common timing advance,
one or more derivatives of the common frequency adjustment,
a validity duration associated with the common timing advance or the common frequency adjustment,
a reference location for UEs in the second state,
a location drift associated with the reference location,
a location drift rate associated with the reference location,
a validity duration associated with the reference location,
one or more timing advance commands or frequency adjustment commands received by the UE within a duration of time or stored in a buffer at the UE, or
any combination thereof.

16. The method of claim 11, wherein the first random access resource is from the first pool of random access resources based at least in part on the state of the UE being the first state, the method further comprising:
transmitting, based at least in part on failing to receive a random access response message in response to the first random access message, a third random access message using a second random access resource from the second pool of random access resources despite being in the first state.

17. The method of claim 16, further comprising:
applying a timing advance, a frequency adjustment, or both, to the third random access message based at least in part on measurements of one or more signals from the navigation satellite system.

18. The method of claim 11, wherein the control information comprises a flag indicating whether a cell associated with the control information supports random access procedures for UEs in the second state with respect to the navigation satellite system.

19. The method of claim 11, wherein:
the first state with respect to the navigation satellite system comprises the UE being able to obtain its location using the navigation satellite system, being capable of using the navigation satellite system, or both, and
the second state with respect to the navigation satellite system comprises the UE being unable to obtain its location using the navigation satellite system, being incapable of using the navigation satellite system, or both.

20. A non-transitory computer-readable medium storing code for wireless communications, the code comprising instructions executable by one or more processors to:
receive control information that indicates a first pool of random access resources for UEs in a first state with respect to a navigation satellite system and a second pool of random access resources for UEs in a second state with respect to the navigation satellite system; and
transmit a first random access message using a first random access resource, wherein whether the first random access resource is from the first pool of random access resources or the second pool of random access resources is based at least in part on a state of a UE with respect to the navigation satellite system.
